(19) United States
(12) Patent Application Publication
(10) Pub. No.: US 2013/0194409 A1
(43) Pub. Date: Aug. 1, 2013

(54) MULTI-PHOTON FLUOROSCOPY ATTACHMENT MODULE FOR A SURGICAL MICROSCOPE

(71) Applicant: Leica Microsystems (Schweiz) AG, Heerbrugg (CH)

(72) Inventor: Ulrich Sander, Rebstein (CH)

(73) Assignee: Leica Microsystems (Schweiz) AG, Heerbrugg (CH)

(21) Appl. No.: 13/749,898

(22) Filed: Jan. 25, 2013

(30) Foreign Application Priority Data
Jan. 31, 2012 (DE) 10 2012 201 371.7

(51) Int. Cl. G01N 21/64; H04N 7/18

(52) U.S. Cl. CPC G01N 21/64; H04N 7/18
USPC 348/79; 250/458.1; 250/216; 250/578.1

(57) ABSTRACT

The present invention relates to an attachment module (100) for a surgical microscope (10), the attachment module (100) being insertable into a main optical path between an objective (11) of the surgical microscope and an object (O) being observed, and including: a multi-photon fluoroscope (110) including a light source (111) for emitting excitation light, a scanning device (112) for directing the excitation light onto the object (O), and a detector (113) for detecting fluorescent light emitted from the object (O); and input coupling optics (120) for reflecting the excitation light from the scanning device onto the object (O).

### CROSS REFERENCE TO RELATED APPLICATIONS

This application claims priority of German patent application number 10 2012 201 371.7 filed Jan. 31, 2012, the entire disclosure of which is incorporated by reference herein.

### FIELD OF THE INVENTION

The present invention relates to an attachment module for a surgical microscope, an examination device including such an attachment module, and to a microscope system including such an examination device.

### BACKGROUND OF THE INVENTION

In microscope-assisted surgery, the light-microscopic imaging may be supported by other methods. For example, it is known from the article “Combining Optical Coherence Tomography (OCT) with an Operating Microscope” by E. Lankenau et al., Advances in Medical Engineering, Springer Verlag, Vol. 114, pp. 343-348, that a surgical microscope may be equipped with an OCT unit so that, particularly in ophthalmology, images from deeper layers can be made available in addition to light-microscopic images of the eye. The magnification of a surgical microscope and that of an OCT unit are on the same order of magnitude.

In neurosurgery, fluorescence microscopy is used in addition to light-microscopic imaging, as described, for example, in DE 10 2005 005 984 A1. In this approach, tissue is excited to fluoresce by administration of marker chemicals to be able to detect tissue changes. The magnification in fluorescence microscopy is also similar to that in light microscopy.

However, especially for pathological assessment of tissues, higher magnifications are desirable.

The intension is, for example, to be able to better distinguish healthy from diseased tissue, so that, for example, a surgeon can see whether he or she has removed all of the tumor tissue. This is particularly important in fields such as brain surgery, where neither too much nor too little tissue should be removed.

### SUMMARY OF THE INVENTION

The present invention presents an attachment module for a surgical microscope, an examination device including such an attachment module, and a microscope system including such an examination device, according the independent claims. The term “attachment module” as used herein is understood to refer to a module that is to be disposed for use between the object to be observed and the main objective of the microscope. Advantageous embodiments are described herein.

An attachment module according to the present invention comprises a multi-photon fluoroscope including a light source for emitting excitation light, a scanning device for directing the excitation light onto the object, and a detector for detecting fluorescent light emitted from the object. The attachment module also comprises input coupling optics for reflecting the excitation light from the scanning device onto the object.

An examination device according to the present invention comprises an attachment module as summarized above, and a controller adapted to control the multi-photon fluoroscope and to compute from the detected fluorescent light a reconstructed image of the object.

A microscope system according to the present invention comprises a light microscope, in particular a surgical microscope, for generating a microscopic image, and an examination device as summarized above.

### ADVANTAGES OF THE INVENTION

The present invention provides a way of equipping a surgical microscope with a multi-photon fluoroscope so that, in addition to the light-microscopic image, a reconstructed image of much higher magnification can also be made available intraoperatively. The intraoperative use is particularly advantageous because, on the one hand, it significantly reduces any required waiting and interruption times and, on the other hand, it has hardly any side effects for the patient.

Multi-photon fluorescence typically uses a laser scanning technique where the object to be observed is scanned with a special laser beam. The illuminated spot is excited to emit multi-photon (mostly two-photon) fluorescence. The fluorescent light is captured, analyzed and used to reconstruct an image. The principle of operation resembles that of a confocal laser scanning method, which is known in principle from WO 2010/146134 A2 and, therefore, will not be discussed in greater detail herein.

However, while confocal laser scanning microscopy has a penetration depth of 50-80 μm, depending on the specimen, multi-photon fluorescence makes it possible to reach deeper regions at a depth of, for example, 200 μm, in very favorable cases even down to 1 mm. This makes it possible to capture images of living tissues, which would otherwise be inaccessible for imaging.

Multi-photon fluorescence requires sharp focusing of the excitation light. Therefore, a special objective having a very short focal length, in particular smaller than 10 mm, and a high numerical aperture, in particular greater than 0.3 is used. The special objective may form part of or be separate from the attachment module. It may be a non-contact objective or a contact objective (e.g., contact glass, contact lens).

One preferred embodiment of the attachment module additionally has a corrective converging lens which is disposed at the objective end of the attachment module and shortens the focal length of the objective of the surgical microscope. This, particularly in combination with the special objective, provides special advantages in terms of compensating for the presence of the special objective in the light-microscopic beam path.

A microscope system according to the present invention is particularly advantageous in surgical applications. When a multi-photon fluoroscope is combined with a surgical microscope, the fluoroscope may be used, in particular, to examine the cell structure, for example in order to examine specific regions of tissue. The multi-photon fluoroscope makes it possible to resolve the cell structure during surgery, and thus, for example, to distinguish healthy and diseased tissue. To this end, the reconstructed image may advantageously also be transmitted to a remote location, for example, a pathological laboratory.

The use of a microscope system according to the present invention in medical/surgical applications is particularly gentle for the patient. The distinction between healthy and diseased tissue can be made quickly and reliably. Today, tissue characterization is typically performed using fluorescence microscopy and rapid sectioning. Both methods are relatively onerous for the patient. In conventional fluorescence microscopy, the patent must ingest marker chemicals, which often have strong side effects. Moreover, differentiation between healthy and diseased tissue by means of this method is often inaccurate, so that mostly too much or too little tissue is removed, both of which has unwanted consequences. In the rapid-section technique, tissue is removed and examined. This may also have a significant negative impact on the patient and, by nature, results in healthy tissue being removed as well. In contrast, graphical differentiation between healthy and diseased tissue, as enabled by the present invention, does not require additional interventions and is therefore particularly gentle. In particular, due to the stimulated emissions, it is not necessarily required to administer chemicals for multi-photon fluoroscopy.

Preferably, the microscope system includes a display unit, such as, for example, a monitor, for displaying the reconstructed image. If the microscope system has a camera, the light-microscopic image may also be displayed on the display unit.

It is advantageous to inject the reconstructed image into an observation beam path of the surgical microscope using an image overlay device as described, for example, in EP 1 224 499 B1. A stereomicroscope, such as the one described therein, may be advantageously used as the surgical microscope. Thus, the surgeon may keep his or her eyes looking through the microscope during surgery and does not have to look back and forth an unnecessary number of times.

A combined image is generated from the reconstructed image and the light-microscopic image, preferably by means of the image overlay device. For the observer of the combined image, it is advantageous both to see the fine structure of the image captured by the multi-photon fluoroscope and to obtain an overview through the microscope image. Advantageously, the reconstructed image, alternatively or in addition to overlaying with the microscopic image, is shown in a separate portion, separately from the microscopic image. The operator can thus see the reconstructed image, without having to look up from the microscope.

When a stereomicroscope is used as the surgical microscope, image overlay is advantageously performed three-dimensionally using different images for each observation beam path. The different images are generated, in particular, by the processing unit.

The present invention may be advantageously used, for example, in ophthalmology for examining the retina, the vitreous body and/or the anterior ocular media. Another preferred field of application is the identification of tumor boundaries and tissue differentiation in brain and skin surgery. Thus, it is possible, for example, to avoid biopsies.

Further advantages and embodiments of the present invention will become apparent from the description and the accompanying drawings.

It will be understood that the aforementioned features and those described below can be used not only in the specified combinations, but also in other combinations or alone without departing from the scope of the present invention.

The present invention is schematically illustrated in the drawings using an exemplary embodiment, and will be described below in detail with reference to the drawings.

### BRIEF DESCRIPTION OF THE DRAWING FIGURE

FIG. 1 is a schematic side view of a preferred embodiment of a microscope system according to the present invention.

### DETAILED DESCRIPTION OF THE INVENTION

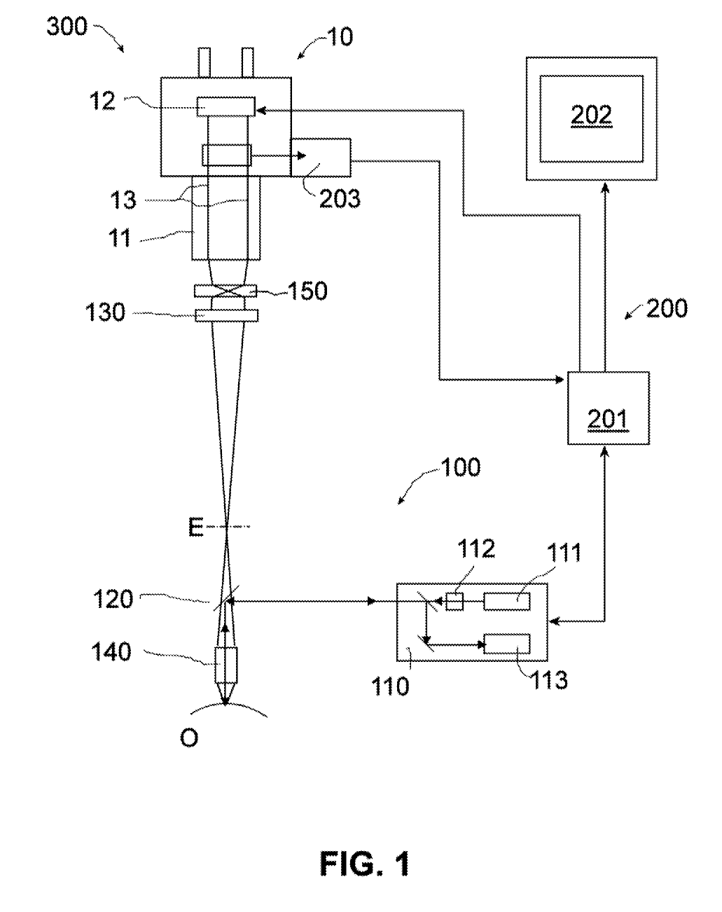

In FIG. 1, a preferred microscope system is shown in schematic view and denoted as a whole by 300. In the preferred embodiment, microscope system 300 includes a surgical microscope 10 as a light microscope and an examination device 200.

Examination device 200 includes an attachment module 100. Attachment module 100 is placed during use in the main optical path of surgical microscope 10 between objective 11 and the object O being observed. To this end, the attachment module may be attached to surgical microscope 10 itself or to a support (not shown), on which the surgical microscope may also be mounted. Attachment module 100 is in particular movably supported so that it can be inserted into the main optical path as needed and removed therefrom after use.

Attachment module 100 has a multi-photon fluoroscope 110 which includes a light source, here in the form of an infrared laser 111, for emitting excitation light, a scanning device, here in the form of a scanning mirror 112, for directing the excitation light onto object O, and a detector 113 for detecting the fluorescent flight emitted from object O. Attachment module 100 further has input coupling optics, here in the form of a beam-splitting mirror 120, to reflect the excitation light from the scanning device onto object O.

The attachment module further includes a special objective 140 at the object end thereof to focus the reflected excitation light onto object O. For this purpose, the special objective has a relatively short focal length and a relatively large numerical aperture. As shown, the special objective may be a non-contact objective. However, in particular in ophthalmology, it is advantageous to use contact objectives, such as contact lenses.

Special objective 140 projects an image of object O into an intermediate image plane E. This image is initially not at the focus of surgical microscope 10, so that, furthermore, a correcting converging lens 130 is preferably provided at the (microscope-)objective end of the attachment module to reduce the focal length of objective 11 of surgical microscope 10 such that, overall, the object continues to be sharply imaged in the surgical microscope.

Due to the formation of the intermediate image at E, the beam paths for the right and left eyepieces of the surgical microscope are exchanged. This is reversed by an inverter 150. The inverter is preferably provided in the attachment module at the objective end thereof between objective 11 of surgical microscope 10 and intermediate image plane E.

In addition to attachment module 100, examination device 200 also includes a controller 201 (e.g., a processing unit). The controller is programmed to perform the steps described above. In particular, controller 201 is adapted to control multi-photon fluoroscope 110 and other components of the microscope system, and to compute a reconstructed image of object O.

Examination device 200 further includes a camera 203 and a display unit, here in the form of a monitor 202. The monitor may also be connected to an external computer unit, such as a PC, for visual display and/or further data processing, the external computer unit in turn being connected to controller 201.

Camera 203 is attached to surgical microscope 10, and thus may capture a light-microscopic image of object O. The image captured by the camera is transmitted to controller 201 for further processing, display and/or storage. The reconstructed image and the captured image are preferably displayed on the monitor. In particular, it is possible to display on monitor 202 the view as seen by the observer or operator; i.e., in particular, the microscope image and, possibly, overlaid data. The monitor and/or the external computer unit may be suitably used, in particular, for remote monitoring or viewing of the examination or surgical procedure.

Surgical microscope 10 is configured as a stereomicroscope having a main objective 11, from which originate two observation beam paths 13 (stereo beam paths), as well as an image overlay device 12. The microscope contains optics such as lenses, mirrors and prisms, as is known to those skilled in the art.

Using such an image overlay device 12, image data, in particular the reconstructed image, but also numerical or textual information, crosshairs, and the like, can be overlaid on the microscope image in correlation with the respective microscope image. For example, the reconstructed image can be projected onto the particular surgical site represented by the surgical image, and thus overlaid on the microscope image, to enable better matching of the diagnosis and surgery. Other image overlays (numerical and textual information, e.g. on size ranges, crosshairs, indicating arrows, etc.) are thereby also made possible. For image overlay, controller 201 controls image overlay device 12 in microscope 10. Image overlay is known per se, so that reference can be made in this connection to known literature such as, for example, EP 1 224 499 B1. Three-dimensional image overlay is also possible, for example, using different images for each beam path of a stereoscopic surgical microscope.

As a result of the image overlay, when the surgeon views object O through surgical microscope 10, he or she sees a combined image of a microscopic image having a first magnification and a reconstructed (fluoroscopic) image having a second, significantly higher magnification. In an exemplary use of the microscope system according to the present invention for removing diseased tissue, first exposed regions are examined using the multi-photon fluoroscope, and diseased tissue is removed under the surgical microscope. The regions which thus appear are then examined using the multi-photon fluoroscope again, and so on.

What is claimed is:

1. An attachment module (100) for a surgical microscope (10), the attachment module (100) being insertable into a main optical path between an objective (11) of the surgical microscope and an object (O) being observed by the surgical microscope, the attachment module comprising:
a multi-photon fluoroscope (110) including a light source (111) for emitting excitation light, a scanning device (112) for directing the excitation light for illuminating the object (O), and a detector (113) for detecting fluorescent light emitted from the object (O); and
input coupling optics (120) for reflecting the excitation light from the scanning device (112) onto the object (O).

2. The attachment module as recited in claim 1, further comprising a special objective (140) at an object end thereof for focusing the reflected excitation light onto the object (O).

3. The attachment module as recited in claim 2, wherein the special objective (140) is a contact objective.

4. The attachment module as recited in claim 2, wherein the special objective (140) is a non-contact objective.

5. The attachment module as recited in claim 2, wherein the surgical microscope has a pair of observation beam paths (13), and the attachment module further comprises an inverter (150) at the objective end thereof for exchanging the observation beam paths (13) for the surgical microscope.

6. The attachment module as recited in claim 1, further comprising a corrective converging lens (130) at an objective end thereof for shortening the focal length of the objective (11).

7. An examination device (200) comprising:
an attachment module (100) for a surgical microscope, the attachment module (100) including:
a multi-photon fluoroscope (110) including a light source (111) for emitting excitation light, a scanning device (112) for directing the excitation light for illuminating the object (O), and a detector (113) for detecting fluorescent light emitted from the object (O); and
input coupling optics (120) for reflecting the excitation light from the scanning device (112) onto the object (O),
wherein the attachment module (100) is insertable into a main optical path between an objective (11) of the surgical microscope and an object (O) being observed by the surgical microscope; and
a controller (201) adapted to control the multi-photon fluoroscope (110) and to compute from the detected fluorescent light a reconstructed image of the object (O).

8. The examination device (200) as recited in claim 7, further comprising a display unit (202), and wherein the controller (201) is adapted to display the reconstructed image of the object (O) on the display unit (202).

9. The examination device (200) as recited in claim 8, further comprising a camera (203) for capturing a light-microscopic image of the object (O), and wherein the controller (201) is adapted to display the light-microscopic image of the object (O) captured by the camera (203) on the display unit (202).

10. A microscope system (300) comprising:
a light microscope (10 for generating a microscopic image of an object (O); and
an examination device (200) comprising:
an attachment module (100) for the light microscope, the attachment module (100) including:
a multi-photon fluoroscope (110) including a light source (111) for emitting excitation light, a scanning device (112) for directing the excitation light for illuminating the object (O), and a detector (113) for detecting fluorescent light emitted from the object (O); and
input coupling optics (120) for reflecting the excitation light from the scanning device (112) onto the object (O),
wherein the attachment module (100) is insertable into a main optical path between an objective (11) of the light microscope and the object (O); and
a controller (201) adapted to control the multi-photon fluoroscope (110) and to compute from the detected fluorescent light a reconstructed image of the object (O).

11. The microscope system (300) as recited in claim 10, wherein the light microscope is a surgical microscope.

12. The microscope system (300) as recited in claim 11, further comprising an image overlay device (12) which injects the reconstructed image of the object (O) into an observation beam path (13) of the light microscope (10).

13. The microscope system (300) as recited in claim 12, wherein the controller (201) is adapted to control the image overlay device (12) to display only the microscope image, only the image to be overlaid, or an overlaid or side-by-side representation of both images.

14. The microscope system (300) as recited in claim 13, wherein the light microscope (10) is configured as a stereomicroscope having at least two observation beam paths (13).

15. The microscope system (300) according to claim 14, wherein the controller (201) is adapted to overlay the reconstructed image three-dimensionally using different images for each of the at least two observation beam paths (13).
